(19) United States
(12) Patent Application Publication
(10) Pub. No.: US 2009/0303508 A1
(43) Pub. Date: Dec. 10, 2009

(54) IMAGE READING APPARATUS AND IMAGE FORMING APPARATUS

(75) Inventor: Kunihiko Tanaka, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/479,903

(22) Filed: Jun. 8, 2009

(30) Foreign Application Priority Data
Jun. 9, 2008 (JP) 2008-150779

(51) Int. Cl. H04N 1/60

(52) U.S. Cl. 358/1.9

(57) ABSTRACT

An image reading apparatus includes: an image reading unit for reading an original image at a first resolution and converting the read original image into first image data; a data analysis unit for analyzing the first image data; a resolution determination unit for determining an appropriate second resolution on the basis of an analysis result of the data analysis unit; and a resolution conversion unit for converting the first image data into second image data relating to the second resolution and outputting the second image data.

### BACKGROUND OF THE INVENTION

1. Field of the Invention

The present invention relates to an image reading apparatus having functions for reading an original image at a predetermined resolution and outputting corresponding image data, and to an image forming apparatus employing the image reading apparatus.

2. Description of the Background Art

In recent years, so-called paperlessness, in which paper documents are digitized, has been promoted in business enterprises and institutions such as local authorities and governments. Conventionally, by digitizing documents stored on paper media, information sharing is facilitated, searchability is improved, management costs are reduced, and so on. To digitize a paper document, for example, an image reading apparatus serving as a peripheral device is network-connected to an information processing apparatus such as a personal computer (PC). The image reading apparatus is used to digitize an image on the document, whereupon digitized image data are transmitted to the information processing apparatus and stored in a predetermined area of a storage apparatus annexed to the information processing apparatus.

To transmit the image data to the information processing apparatus, various items such as a color mode (color, monochrome, or grayscale) of the original image, an original image size, a description of an image compression method, a description of an image format, and a reading resolution must be set by a user in advance. However, to set these items appropriately, the user must be familiar with the content of the respective items, and placing this burden on the user is undesirable in terms of user friendliness.

From this viewpoint, a technique in which original image data are determined to be either image data or text data, an appropriate compression method is selected in accordance with the determination result, and the image is compressed using the selected compression method is known (see Japanese Unexamined Patent Application Publication No. 2000-307854).

In another known technique, an image data transmission system constituted by an image reading apparatus and a PC to which image data from the image reading apparatus are transmitted performs image reading at a resolution that corresponds to an information processing capacity of the PC to which the image data from the image reading apparatus are transmitted (see Japanese Unexamined Patent Application Publication No. 2005-159704).

Incidentally, when the image reading resolution, from among the various items described above, is set at a high resolution during an original reading operation, a detailed image in which even the detailed portions of the image are read is obtained, but the memory size of the image increases. When the original is read at a low resolution, on the other hand, the memory size of the image is reduced, but a rough image in which characters and the like are difficult to read is obtained.

In other words, in a case where the image reading resolution is not set at an appropriate level for each original, the volume of the image data increases if the clarity of characters and the like is prioritized such that the storage capacity of the storage apparatus is consumed needlessly, but when suppression of storage capacity consumption is prioritized, characters and the like become difficult to read such that a desired aim is not achieved. Hence, the importance of setting the image reading resolution appropriately for each original is extremely great, and yet conventionally, the user is required to set the image reading resolution for each original. At present, user expertise in relation to the functions of image reading apparatuses range from a beginner level to an expert level, and therefore situations in which a user sets the image reading resolution incorrectly occur frequently. Hence, there exists great demand for the development of a novel technique making it possible to set an image reading resolution for each original appropriately and easily.

### SUMMARY OF THE INVENTION

An object of the present invention is to make it possible to set an image reading resolution for an individual original appropriately and easily, irrespective of the expertise of a user.

An image reading apparatus according to one aspect of the present invention for achieving this object includes: an image reading unit for reading an original image at a first resolution and converting the read original image into first image data; a data analysis unit for analyzing the first image data; a resolution determination unit for determining an appropriate second resolution on the basis of an analysis result of the data analysis unit; and a resolution conversion unit for converting the first image data into second image data relating to the second resolution and outputting the second image data.

Further, an image forming apparatus according to another aspect of the present invention includes the image reading apparatus described above, and an image forming unit for performing an image forming operation on the basis of image data output by the image reading apparatus.

### BRIEF DESCRIPTION OF THE DRAWINGS

FIG. 1 is a function block diagram showing the schematic constitution of a digital complex machine according to an embodiment of the present invention;

FIG. 2 is a flowchart performed by the digital complex machine when using an image reading function; and

FIG. 3 is an illustrative view showing examples of character images following resolution conversion.

### DETAILED DESCRIPTION OF THE PREFERRED EMBODIMENTS

An image reading apparatus and an image forming apparatus according to an embodiment of the present invention will be described in detail below with reference to the drawings. In the following description, a digital complex machine (image forming apparatus) having an image reading function is used as an example of an embodiment of the image reading apparatus according to the present invention.

[Schematic Constitution of Digital Complex Machine]

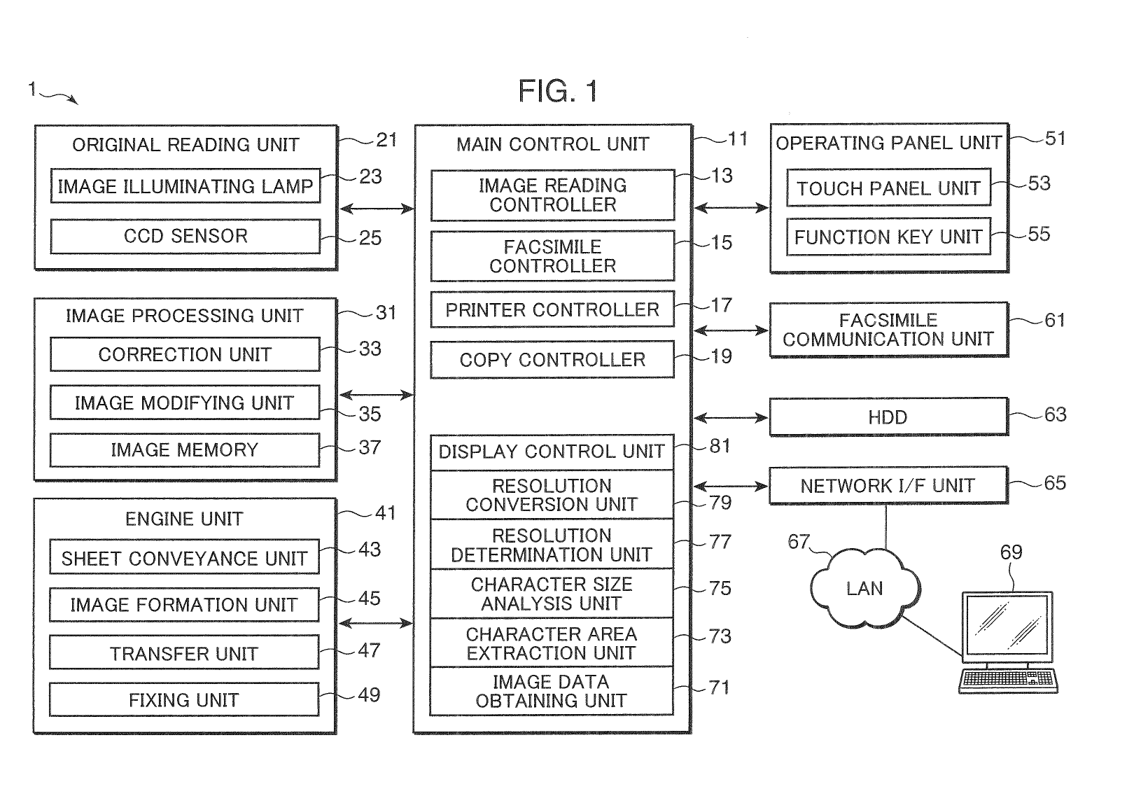

FIG. 1 is a block diagram showing the schematic constitution of a digital complex machine 1 according to this embodiment. The complex machine 1 can be used for various functions including copy jobs, fax transmission jobs, printing jobs, and network transmission (mail transmission and data transmission) jobs, for example, these functions being controlled by a main control unit 11 constituted by a microcomputer, a specialized hardware circuit, and so on. The complex machine 1 includes an original reading unit 21, an image processing unit 31, an engine unit 41, an operating panel unit 51, a facsimile communication unit 61, an HDD (Hard Disk Drive) 63, and a network I/F (Interface) unit 65 as input/output devices that are connected to the main control unit 11 in order to execute these functions.

The main control unit 11 is installed with an image reading controller 13 that performs operation control to realize the image reading function, a facsimile controller 15 that performs operation control to realize the facsimile function, a printer controller 17 that performs operation control to realize the printer function, and a copy controller 19 that performs operation control to realize the copy function, and performs overall control of the operations of the entire machine.

In this embodiment, the original reading unit 21, which constitutes a part of the image reading apparatus, includes an image illuminating lamp 23 and a CCD (Charge Coupled Device) sensor 25. The original reading unit 21 illuminates an original using the image illuminating lamp 23, and optically reads an image from the original by receiving reflection light from the original in the CCD sensor 25. The original reading unit 21 according to this embodiment is capable of reading an original extending over a plurality of pages sequentially in page units at a predetermined resolution. Image data corresponding to the read image are output to the image processing unit 31.

The image processing unit 31 includes a correction unit 33, an image modifying unit 35, and an image memory 37. The image processing unit 31 uses the correction unit 33 and the image modifying unit 35 as required to process the image data read by the original reading unit 21, and then either stores the processed image data in the image memory 37 or outputs the image data to the engine unit 41, the facsimile communication unit 61, and so on. The correction unit 33 performs predetermined correction processing such as level correction and gamma correction on the image data read by the original reading unit 21. The image modifying unit 35 performs various types of modification processing such as processing to compress or expand the image data and processing to enlarge or reduce the image data.

The engine unit 41 includes a sheet conveyance unit 43 constituted by a sheet feeding cassette, a sheet feeding roller, and so on, not shown in the drawing, an image forming unit 45 constituted by a photosensitive drum, an exposure apparatus, a developing apparatus, and so on, not shown in the drawing, a transfer unit 47 constituted by a transfer roller and so on, not shown in the drawing, and a fixing unit 49 constituted by a fixing roller and so on, not shown in the drawing. The engine unit 41 prints an image onto a sheet of paper using image data such as the image data read by the original reading unit 21, image data transmitted from a client PC (Personal Computer) or the like via the network I/F unit 65 using a LAN (Local Area Network), and fax data received by the facsimile communication unit 61 from an external facsimile apparatus or the like. More specifically, the sheet conveyance unit 43 conveys a sheet to the image forming unit 45, whereupon the image forming unit 45 forms a toner image corresponding to the image data, the transfer unit 47 transfers the toner image onto the sheet, and the fixing unit 49 fixes the toner image on the sheet. Thus, an image is formed.

The operating panel unit 51 includes a touch panel unit 53 and a function key unit 55. The operating panel unit 51 is used by a user to perform operations relating to the image reading function, facsimile function, printer function, copy function, and so on, whereby an operation command or the like input by the user is issued to the main control unit 11.

The touch panel unit 53 is constituted by a touch panel unit combining a touch panel and a color LCD (Liquid Crystal Display) or the like. Various setting screens, for example, when the image reading function is executed, a setting screen showing information relating to various items such as a color mode (color, monochrome, or grayscale) of the original image, an original image size, a description of an image compression method, a description of an image format, a reading resolution, and an image reading resolution automatic setting mode, which is closely related to the present invention, are displayed on the touch panel unit 53. The touch panel unit 53 also displays operating buttons for inputting various operation commands when a corresponding button is touched by the user. The touch panel unit 53 is also used to display an electronic document that includes an original image extending over a plurality of pages.

The function key unit 55 includes a plurality of function keys that are operated by the user to select various functions relating to image forming processing, and a shortcut key. The function key unit 55 is used, for example, when the user selectively executes a key input operation of a required function from among functions such as the copy function, the printer function, the image reading function, and the facsimile function, or when the user inputs a number of copies, a copy execution command, and so on.

The facsimile communication unit 61 includes an encoding/decoding unit (not shown), a modulating/demodulating unit (not shown), and an NCU (Network Control Unit) (not shown). The facsimile communication unit 61 transmits the image data of the original read by the original reading unit 21 to a facsimile apparatus or the like via a telephone line and receives image data transmitted from a facsimile apparatus or the like.

The HDD (Hard Disk Drive) 63 is a large capacity storage apparatus for storing various types of data such as the image data read by the original reading unit 21 and an output format set in the image data, and so on. The image data stored in the HDD are used in a program processing in the digital complex machine 1 and the interior of a recording medium, and also viewed from the client PC or the like via the network I/F unit 65 and transferred to a predetermined folder of the client PC, an FTP server, and so on as necessary.

The network I/F unit 65 uses a network interface (10/100 Base-TX) or the like to control transmission/reception of various types of data to and from an external information processing apparatus (to be referred to as a “user terminal” hereafter) 69 such as a user PC connected thereto via the LAN 67.

To set an appropriate resolution automatically on the basis of an analysis result of the image data, irrespective of the expertise of the user, the digital complex machine 1 according to this embodiment includes an image data obtaining unit 71, a character area extraction unit (a part of a data analysis unit) 73, a character size analysis unit (a part of the data analysis unit) 75, a resolution determination unit 77, a resolution conversion unit 79, and a display control unit 81.

The image data obtaining unit 71 obtains image data (first image data) relating to each page of the original read successively by the original reading unit 21 (image reading unit) in page units at a predetermined resolution (first resolution). The character area extraction unit 73 extracts a character area from the image data obtained by the image data obtaining unit 71. The character size analysis unit 75 analyzes character sizes (character font sizes) of the characters included in the character area extracted by the character area extraction unit 73. The resolution determination unit 77 determines an appropriate resolution (second resolution) on the basis of a minimum character size of the character size information obtained in the analysis performed by the character size analysis unit 75. The resolution conversion unit 79 converts the image data relating to the predetermined resolution at the time of the original reading performed by the original reading unit 21 into image data (second image data) relating to the appropriate resolution determined by the resolution determination unit 77 and outputs the converted image data. The display control unit 81 displays an image of an electronic document converted by the resolution conversion unit 79 on the touch panel unit 53.

The predetermined resolution (first resolution) at the time of the original reading performed by the original reading unit 21 is preferably set at a maximum resolution (in this example, a 600 dpi resolution) of a plurality of resolution variations (for example, 200/300/400/600 dpi resolution variations) prepared in advance. To convert image data relating to a low resolution (the 200 dpi resolution, for example) into image data relating to a high resolution (the 400 dpi resolution, for example) and output the converted image data, image processing such as data interpolation must be performed on the original image data. Accordingly, extra processing time is required and the image quality may deteriorate as a result of the resolution conversion.

[Operations of Digital Complex Machine]

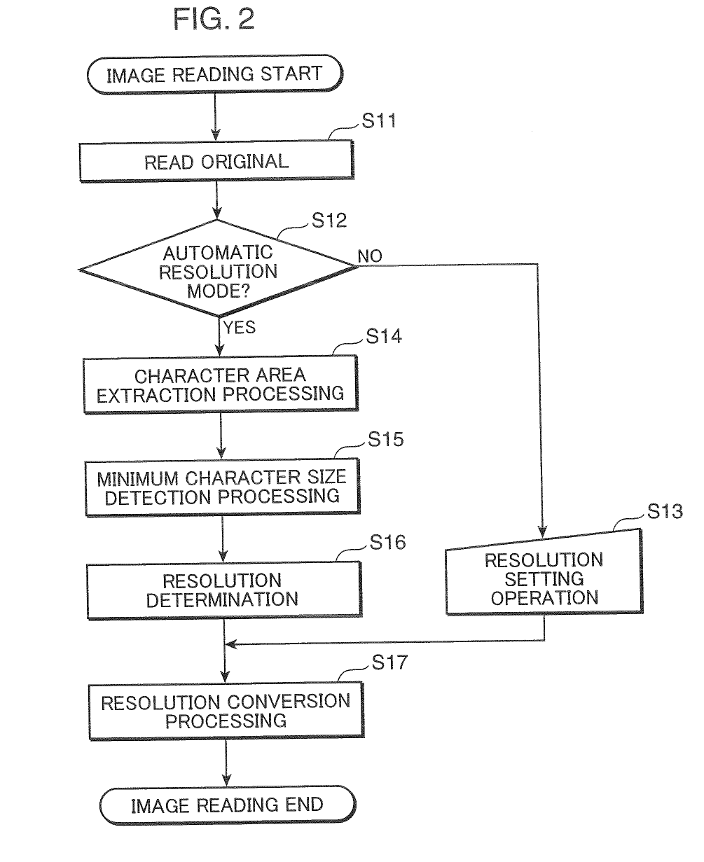

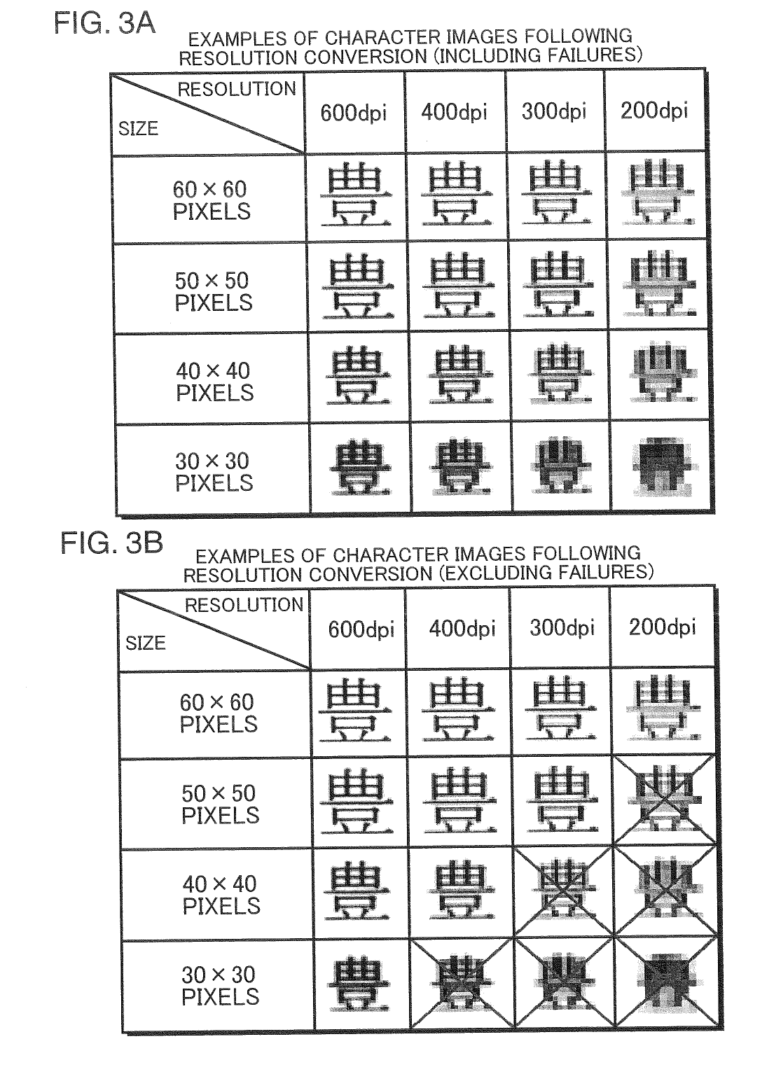

Next, an operation of the digital complex machine 1 according to this embodiment will be described with reference to FIGS. 2 to 3B. FIG. 2 is a flowchart showing an operation of the digital complex machine 1 during use of the image reading function. FIG. 3A is an illustrative view showing examples of character images following resolution conversion, in which failures and successes are intermixed. FIG. 3B is an illustrative view showing examples of character images following resolution conversion, in which failures and successes are separated.

It is assumed as a prerequisite that the digital complex machine 1 has an image reading function for reading an original image of a paper medium document extending over a plurality of pages, an electronic document creation function for creating an electronic document (a PDF: Portable Document Format document, for example) that includes an original image extending over a plurality of pages using the image reading function, and an OCR (Optical Character Recognition) function for recognizing characters in the electronic document created using the electronic document creation function and converting the recognized characters into text.

As shown in FIG. 2, when an original extending over a plurality of pages is set on an automatic original feeding apparatus (not shown) in the original reading unit 21 and the user inputs a command to read the original via the operating panel unit 51, the main control unit 11 transmits an original reading start signal to the original reading unit 21. Upon reception of the start signal, the original reading unit 21 starts to read the original in page units (step S11). The image data read in page units in the step S11 are then transmitted to the image data obtaining unit 71 from the original reading unit 21. Upon reception of the image data, the image data obtaining unit 71 obtains an image relating to the original in page units and stores the obtained image data in the image memory 37.

Next, the main control unit (image reading controller 13) 11 determines whether or not an image reading resolution automatic setting mode has been set (step S12).

When it is determined as a result of the determination in the step S12 that the image reading resolution automatic setting mode has not been set (No in step S12), the main control unit (image reading controller 13) 11 waits for a resolution setting operation to be input by the user (step S13), whereupon the processing flow jumps to a step S17, to be described below.

When it is determined as a result of the determination in the step S12 that the image reading resolution automatic setting mode has been set (Yes in step S12), on the other hand, the character area extraction unit 73 executes processing to extract a character area from the image data obtained by the image data obtaining unit 71 (step S14). More specifically, the character area extraction unit 73 executes processing to extract the character area from the image data obtained by the image data obtaining unit 71 by employing an image processing technique described in Japanese Unexamined Patent Application Publication No. 2006-129203, filed and laid open by the present applicant (incorporated into this embodiment by reference), for example, which “comprises an image processing unit 31 having an image memory 37 including a first image data storage unit and a second image data storage unit for respectively storing image data of an original read by a CCD sensor 25 of an original reading unit 21 in pixel units, an edge determination unit (not shown) for determining whether or not the respective pixels of the first image data and second image data are character pixels, an area separation unit (not shown) for separating the first image data into a character area and a non-character area on the basis of the determination result generated by the edge determination unit, and a correction unit 33 for performing a correction by implementing different image processing on each character area and non-character area of the first image data, whereby the character area and the non-character area are separated with a high degree of precision”.

Next, the character size analysis unit 75 analyzes character sizes (character font sizes) included in the character area extracted by the character area extraction unit 73 and executes processing to detect a minimum character size of the analyzed character sizes (step S15). More specifically, the character size analysis unit 75 executes processing to detect the minimum character size of the characters included in the image data obtained by the image data obtaining unit 71 by employing an image processing technique described in Japanese Unexamined Patent Application Publication No. H5-282492 (incorporated into this embodiment by reference), for example, in which “circumscribed rectangles of black pixel connecting parts are extracted by a circumscribed rectangle extraction unit, circumscribed rectangles which overlap at right angles to a character string direction are combined by a basic rectangle creation unit, histograms of the width and height of a basic rectangle are created by a histogram creation unit, narrow, normal, and wide characters are determined in accordance with the histograms, the width and height of the characters are calculated by a character width/height determination unit, and the character size is determined by a character size calculation unit”.

Next, the resolution determination unit 77 executes processing to determine an appropriate resolution on the basis of the minimum character size analyzed by the character size analysis unit 75 (step S16). In other words, the resolution determination unit 77 determines the appropriate resolution on the basis of the obtained minimum character size by comparing the minimum character size with a predetermined threshold, for example.

A specific example of this processing will now be described. When the plurality of resolution variations prepared in advance are 200/300/400/600 dpi, first to third thresholds T1, T2, T3 (where T3>T2>T1) are set as the predetermined threshold. When a relationship of minimum character size>third threshold T3 is established, the 200 dpi resolution is selected/determined. When a relationship of third threshold T3≧minimum character size>second threshold T2 is established, the 300 dpi resolution is selected/determined. When a relationship of second threshold T2≧minimum character size>first threshold T1 is established, the 400 dpi resolution is selected/determined. When a relationship of first threshold T1≧minimum character size is established, the 600 dpi resolution is selected/determined.

In other words, a character recognition rate of the smallest characters is employed as a reference when selecting/determining an appropriate resolution corresponding to the minimum character size detected in the step S15. More specifically, when the character size in the original image is large, a low resolution is set, and when the character size is small, a high resolution is set. The reason for this is that when the character size in the original image is large, a fixed character recognition rate is obtained even at a low resolution, but when the character size in the original image is small, a high resolution must be set to obtain a fixed character recognition rate.

FIG. 3A shows actual examples of character images obtained when a Chinese character called “Yutaka” and meaning “affluence”, which is read at 600 dpi, i.e. the highest resolution of the plurality of resolution variations 200/300/400/600 dpi, and has a size ranging from 60×60 pixels to 30×30 pixels, is subjected to image conversion at each of the resolutions. It was learned that when the character size is large, the character quality (in other words, the OCR character recognition rate) decreases little even when the resolution is reduced, but when the character size is small, the resolution must be increased to maintain the character quality.

Hence, in the example images shown in FIG. 3A, resolution selection/determination at which the character quality (in other words, the OCR character recognition rate) can be maintained at a predetermined high standard can be realized by setting the first threshold T1 at “35”, the second threshold T2 at “45”, and the third threshold T3 at “55” (where “35”, “45” and “55” denote a pixel count per side), as shown in FIG. 3B.

Next, the resolution conversion unit 79 executes processing to convert the image data relating to the predetermined resolution at the time of the reading performed by the original reading unit 21 into image data relating to the appropriate resolution determined by the resolution determination unit and output the converted image data (step S17). Once this conversion/output processing has been executed, the series of image reading processes is terminated. In other words, in the step S17, the resolution conversion unit 79 performs resolution conversion processing on the original image read by the original reading unit 21 in accordance with either the resolution set by the user in the step S13 (when a manual mode is set) or the resolution determined in the step S16 (when the automatic mode is set).

The resolution conversion processing can be realized by performing zoom processing in accordance with the pre- and post-conversion resolutions. Specifically, when image data relating to the 600 dpi resolution are resolution-converted into image data relating to the 300 dpi resolution, for example, zoom processing corresponding to a 50% reduction is performed, and when image data relating to the 600 dpi resolution are resolution-converted into image data relating to the 200 dpi resolution, zoom processing corresponding to a 33% reduction is performed.

As described above, according to the digital complex machine 1 (image reading apparatus) of this embodiment, when an original image is read at a predetermined resolution, a character area is extracted from the read image data and the character sizes included in the extracted character area are analyzed. A minimum character size is then detected from the analysis result, and an appropriate resolution is determined on the basis of the detected minimum character size. The image data relating to the predetermined resolution at the time of reading are then converted into image data relating to the determined resolution, whereupon the converted image data are output. Hence, an appropriate resolution is set automatically on the basis of the analysis result of the image data, irrespective of the expertise of the user. As a result, a digital complex machine 1 which is conducive to an improvement in user convenience can be provided.

The present invention is not limited to the embodiment described above, and may be modified appropriately within a scope that does not depart from the gist or technical spirit of the invention read from the claims and the entire specification. Image reading apparatuses and image forming apparatuses obtained through such modifications are included in the technical scope of the present invention.

For example, in the embodiment, the digital complex machine 1 having an image reading function was described as an example, but the present invention is not limited to this example, and may be applied as is to an image reading apparatus serving as a peripheral device having an image reading function.

The specific embodiment described above mainly includes inventions having the following constitutions.

An image reading apparatus according to one aspect of the present invention, comprising: an image reading unit for reading an original image at a first resolution and converting the read original image into first image data; a data analysis unit for analyzing the first image data; a resolution determination unit for determining an appropriate second resolution on the basis of an analysis result of the data analysis unit; and a resolution conversion unit for converting the first image data into second image data relating to the second resolution and outputting the second image data.

Further, an image forming apparatus according to another aspect of the present invention includes: an image reading apparatus for reading an original image and outputting image data; and an image forming unit for performing an image forming operation on the basis of the image data output by the image reading apparatus, wherein the image reading apparatus has the constitution described above.

According to this image reading apparatus or image forming apparatus, when the original image is read at the first resolution, a character area is extracted from the read image data, a character size included in the character area is analyzed, and an appropriate resolution is determined on the basis of the image data analysis result. The image data relating to the predetermined resolution at the time of reading are then converted into image data relating to the determined resolution, whereupon the converted image data are output. Hence, an appropriate resolution is set automatically on the basis of the analysis result of the image data, irrespective of the expertise of the user, and as a result, an image reading apparatus which is conducive to an improvement in user convenience can be obtained.

In the above constitution, the data analysis unit preferably extracts a character area from the first image data and analyzes a character size included in the extracted character area, and the resolution determination unit preferably determines the second resolution on the basis of the character size analyzed by the data analysis unit. According to this constitution, the second resolution is determined in accordance with the physical size of the characters included in the first image data.

In this case, a minimum character size is preferably detected from character size information obtained in the analysis performed by the data analysis unit, and the appropriate second resolution is preferably selected from among a plurality of resolution variations prepared in advance, on the basis of the minimum character size. More specifically, the resolution determination unit preferably employs a character recognition rate of characters having the minimum character size as a reference when selecting the appropriate second resolution corresponding to the detected minimum character size. According to this constitution, the resolution can be set such that the minimum character size included in the first data can be recognized at all times.

In the above constitution, the first resolution is preferably a maximum resolution of a plurality of resolution variations prepared in advance. According to this constitution, processing to convert image data relating to a low resolution into image data relating to a high resolution is not required, and therefore image processing such as data interpolation is not required during the resolution conversion.

In this case, the resolution conversion unit may convert the image data relating to the first resolution into the second image data relating to the second resolution by implementing reduction zoom processing on the image data relating to the first resolution. According to this constitution, the resolution conversion processing can be simplified.

This application is based on Japanese Patent Application No. 2008-150779 on Jun. 9, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention herein after defined, they should be construed as being included therein.

What is claimed is:

1. An image reading apparatus comprising:
an image reading unit for reading an original image at a first resolution and converting said read original image into first image data;
a data analysis unit for analyzing said first image data;
a resolution determination unit for determining an appropriate second resolution on the basis of an analysis result of said data analysis unit; and
a resolution conversion unit for converting said first image data into second image data relating to said second resolution and outputting said second image data.

2. The image reading apparatus according to claim 1, wherein said data analysis unit extracts a character area from said first image data and analyzes a character size included in said extracted character area, and
said resolution determination unit determines said second resolution on the basis of said character size analyzed by said data analysis unit.

3. The image reading apparatus according to claim 2, wherein said resolution determination unit detects a minimum character size from character size information obtained in said analysis performed by said data analysis unit, and selects said appropriate second resolution from among a plurality of resolution variations prepared in advance, on the basis of said minimum character size.

4. The image reading apparatus according to claim 3, wherein said resolution determination unit employs a character recognition rate of characters having said minimum character size as a reference when selecting said appropriate second resolution corresponding to said detected minimum character size.

5. The image reading apparatus according to claim 1, wherein said first resolution is a maximum resolution of a plurality of resolution variations prepared in advance.

6. The image reading apparatus according to claim 5, wherein said resolution conversion unit converts said image data relating to said first resolution into said second image data relating to said second resolution by implementing reduction zoom processing on said image data relating to said first resolution.

7. An image forming apparatus comprising:
an image reading apparatus for reading an original image and outputting image data; and
an image forming unit for performing an image forming operation on the basis of said image data output by said image reading apparatus,
wherein said image reading apparatus includes:
an image reading unit for reading said original image at a first resolution and converting said read original image into first image data;
a data analysis unit for analyzing said first image data;
a resolution determination unit for determining an appropriate second resolution on the basis of an analysis result of said data analysis unit; and
a resolution conversion unit for converting said first image data into second image data relating to said second resolution and outputting said second image data.

8. The image forming apparatus according to claim 7, wherein said data analysis unit extracts a character area from said first image data and analyzes a character size included in said extracted character area, and
said resolution determination unit determines said second resolution on the basis of said character size analyzed by said data analysis unit.

9. The image forming apparatus according to claim 8, wherein said resolution determination unit detects a minimum character size from character size information obtained in said analysis performed by said data analysis unit, and selects said appropriate second resolution from among a plurality of resolution variations prepared in advance, on the basis of said minimum character size.

10. The image forming apparatus according to claim 9, wherein said resolution determination unit employs a character recognition rate of characters having said minimum character size as a reference when selecting said appropriate second resolution corresponding to said detected minimum character size.

11. The image forming apparatus according to claim 7, wherein said first resolution is a maximum resolution of a plurality of resolution variations prepared in advance.

12. The image forming apparatus according to claim 11, wherein said resolution conversion unit converts said image data relating to said first resolution into said second image data relating to said second resolution by implementing reduction zoom processing on said image data relating to said first resolution.
